(19) United States
(12) Patent Application Publication
(10) Pub. No.: US 2012/0276915 A1
(43) Pub. Date: Nov. 1, 2012

(54) Signaling To Establish Multipoint Communications

(75) Inventors: Keiichi Kubota, Weybridge (GB); Brian Alexander Martin, Farnham (GB); Luis Miguel Santos Barreto, Camberley (GB); Christopher Peter Callender, Fleet (GB)

(73) Assignee: Renesas Mobile Corporation

(21) Appl. No.: 13/096,124

(22) Filed: Apr. 28, 2011

(51) Int. Cl. H04W 4/00; H04W 72/04

(52) U.S. Cl. 455/452.1; 455/422.1

(57) ABSTRACT

A user equipment UE sends to a network an indication that a neighbor cell is suitable for data communications with the UE. The UE is in a state with a serving cell in which no dedicated physical channel is allocated to the UE. In response to the indication the network and UE conduct multipoint communications between the UE and the serving cell and the neighbor cell using a common channel configuration the UE receives from at least one of the serving cell and the neighbor cell. In a UTRAN embodiment the state is a CELL-FACH state. Various embodiments details specific RRC messages for various signaling, and in one embodiment there are different procedures depending on whether the serving cell and the neighbor cell belong to the same or different NodeB groups. Further embodiments address when the neighbor cell is no longer suitable for multipoint data communications with the UE.

### TECHNICAL FIELD

The exemplary and non-limiting embodiments of this invention relate generally to wireless communication systems, methods, devices and computer programs and, more specifically, relate to signaling in support of and network coordination for multipoint communications between a network and a user equipment.

### BACKGROUND

The following abbreviations that may be found in the specification and/or the drawing figures are defined as follows:

3GPP third generation partnership project

DL downlink (network towards UE)

E-DCH enhanced dedicated (physical) channel

E-DPCCH enhanced dedicated physical control channel

E-DPDCH enhanced dedicated physical data channel

E-HICH E-DCH HARQ acknowledgement indicator channel

E-RGCH E-DCH relative grant channel

E-RNTI E-DCH radio network temporary identifier

FACH forward access channel

HARQ hybrid automatic repeat request

H-RNTI HS-DSCH radio network temporary identifier

HSPDA high speed downlink packet access

HS-DSCH high speed downlink shared channel

HS-DPCCH high speed dedicated physical control channel

IE information element

NCL neighbor cell list

Node B base station

RF radio frequency

RNC radio network controller

RRC radio resource control

SI system information

SIB system information block

UE user equipment

UL uplink (UE towards network)

UTRAN universal terrestrial radio access network

Continuing improvements of the UTRAN system have recently included the investigation of a CELL-FACH enhancement which in part intends to improve cell reselection. A UE in the CELL-FACH state has no dedicated physical channel allocated to it, but instead it continuously monitors the FACH in the DL and is assigned a random access channel RACH for accessing an uplink transport channel. While in the CELL-FACH state the UE can have only one serving cell, and so it performs cell reselection according to specified reselection rules, typically to change the current serving cell to a better quality neighbor cell.

In current specifications the UE does this by first obtaining the system information of the neighbor cell (typically 1.28 seconds) then sends a cell update message upon cell reselection while in the in CELL-FACH state so that the network can provide a dedicated resource on the new serving cell for the UE. The network provides this resource in a Cell Update Confirm message, and the cell update procedure can take up to a full second to perform. These conventional procedures are detailed at 3GPP TS 25.331 v10.3.1 (2011 April) subclause 8.3.1. But until this cell update procedure is complete, the UE cannot perform user data transmission and reception and so there is a time, on the order of up to a few seconds, during which service is disrupted due to the cell reselection.

Also, in Release-8 of UTRAN there was introduced an “Enhanced Uplink in CELL-FACH state and idle mode” feature, by which the UE cannot perform cell reselection when it has an uplink resource allocated to it by the network. So a UE capable of this enhanced uplink in CELL-FACH state and idle mode is at risk of losing its synchronization to its serving cell due to that cell reselection restriction. It is expected that the CELL-FACH enhancement noted above will address this particular issue (e.g., in 3GPP Release 11) by allowing reselection during an ongoing E-DCH transmission. But still some improvements are required to enable this while avoiding or minimizing other problems.

Finally, another problem arises where the UE's reception of both the serving cell and the detected neighbor cells are all relatively weak. In this case reception on only a single cell would be unreliable, and potentially under some fading conditions the UE may reselect back and forth between difference cells in a kind of ping-pong effect as a result of poor signal reception which is only transient at the UE. Reception from multiple cells simultaneously would increase the reliability since the UE could then combine the successful reception from different cells. On balance this could potentially reduce the uplink signaling load since the UE would engage in fewer total reselections and corresponding cell update procedures.

Exemplary embodiments detailed below with particularity provide solutions to the above problems in that they detail UE and network actions for multipoint reception at the UE in the CELL-FACH state from multiple network cells. While it is possible that the UE could autonomously find all the network cells it needs for multipoint communications and the network could ‘blindly’ schedule on all the possible cells to that UE, this uncoordinated approach would result in wasted radio resources. Thus the exemplary embodiments include control signaling for making the multipoint communications both more targeted and more efficient from the perspective of total radio resources used perspective.

### SUMMARY

The foregoing and other problems are overcome, and other advantages are realized, by the use of the exemplary embodiments of this invention.

In a first exemplary embodiment of the invention there is a method comprising: receiving from a user equipment an indication that a neighbor cell is suitable for data communications with the user equipment; and in response coordinating for the serving cell and the neighbor cell to conduct multipoint communications with the user equipment. In this embodiment the user equipment is in a state with a serving cell in which no dedicated physical channel is allocated to the user equipment.

In a second exemplary embodiment of the invention there is an apparatus comprising at least one processor and at least one memory storing a computer program. In this embodiment the at least one memory with the computer program is configured with the at least one processor to cause the apparatus to at least receive from a user equipment an indication that a neighbor cell is suitable for data communications with the user equipment, in which the user equipment is in a state with a serving cell in which no dedicated physical channel is allocated to the user equipment; and in response, coordinate for the serving cell and the neighbor cell to conduct multipoint communications with the user equipment

In a third exemplary embodiment of the invention there is a computer readable memory storing a computer program which when executed by at least one processor results in actions comprising: receiving from a user equipment an indication that a neighbor cell is suitable for data communications with the user equipment, in which the user equipment is in a state with a serving cell in which no dedicated physical channel is allocated to the user equipment; and in response, coordinating for the serving cell and the neighbor cell to conduct multipoint communications with the user equipment.

In a fourth exemplary embodiment of the invention there is a method comprising: sending from a user equipment an indication that a neighbor cell is suitable for data communications with the user equipment; and in response conducting multipoint communications with the serving cell and the neighbor cell using a common channel configuration received from at least one of the serving cell and the neighbor cell. In this embodiment also the user equipment is in a state with a serving cell in which no dedicated physical channel is allocated to the user equipment.

In a fifth exemplary embodiment of the invention there is an apparatus comprising at least one processor and at least one memory storing a computer program. In this embodiment the at least one memory with the computer program is configured with the at least one processor to cause the apparatus to at least send from a user equipment an indication that a neighbor cell is suitable for data communications with the user equipment, in which the user equipment is in a state with a serving cell in which no dedicated physical channel is allocated to the user equipment; and in response, conduct multipoint communications with the serving cell and the neighbor cell using a common channel configuration received from at least one of the serving cell and the neighbor cell.

In a sixth exemplary embodiment of the invention there is a computer readable memory storing a computer program which when executed by at least one apparatus results in actions comprising: sending from a user equipment an indication that a neighbor cell is suitable for data communications with the user equipment, in which the user equipment is in a state with a serving cell in which no dedicated physical channel is allocated to the user equipment; and in response, conducting multipoint communications with the serving cell and the neighbor cell using a common channel configuration received from at least one of the serving cell and the neighbor cell.

By example the first through third exemplary embodiments above are from the network's perspective while the fourth through sixth exemplary embodiments are from the UE's perspective. These and other embodiments and aspects are detailed below with particularity.

### BRIEF DESCRIPTION OF THE DRAWINGS

FIG. 1 is a schematic diagram of adjacent NodeBs with a UE moving amongst their cells and is an environment in which embodiments of the invention may be advantageously practiced.

FIG. 2A is a signaling diagram illustrating processes for establishing multipoint communications between two network cells and a UE according to an exemplary embodiment of the invention.

FIG. 2B is a signaling diagram illustrating processes for discontinuing the multipoint communications first established at FIG. 2A according to an exemplary embodiment of the invention.

FIG. 3A is a signaling diagram similar to FIG. 2A but illustrating alternative processes for establishing multipoint communications between two network cells and a UE according to an exemplary embodiment of the invention.

FIG. 3B is a signaling diagram illustrating alternative processes for discontinuing the multipoint communications first established at FIG. 3A according to an exemplary embodiment of the invention.

FIGS. 4A-B are logic flow diagrams that illustrates the operation of a method, and a result of execution of computer program instructions embodied on a computer readable memory, in accordance with the exemplary embodiments of this invention.

FIG. 5 is a simplified block diagram of the UE and a NodeB from FIG. 1 and also a higher network node, which are exemplary electronic devices suitable for use in practicing the exemplary embodiments of this invention.

### DETAILED DESCRIPTION

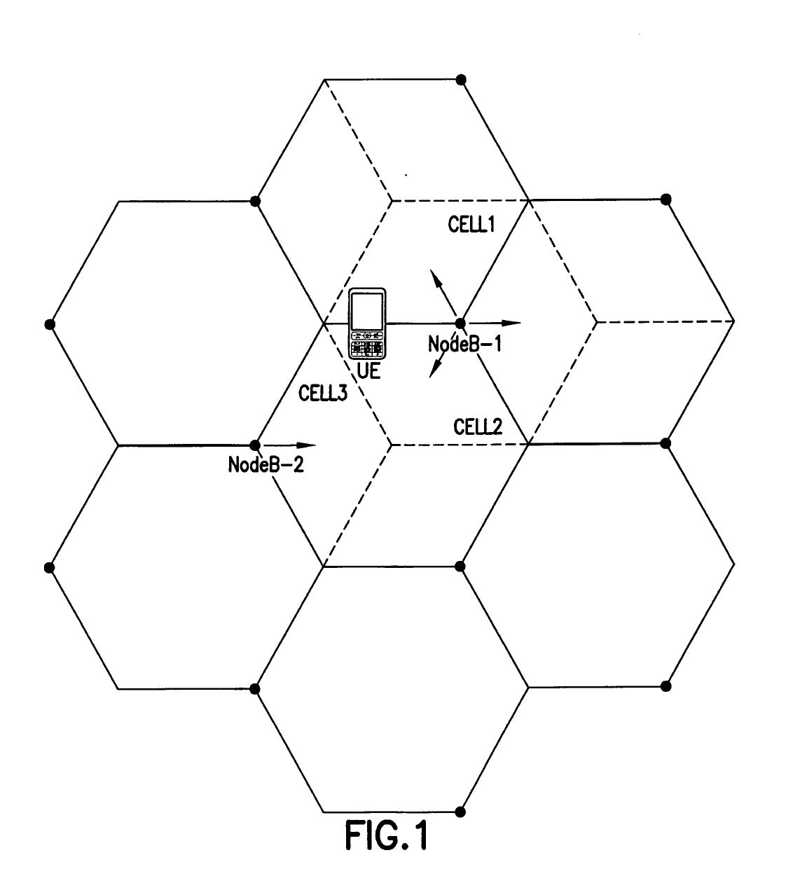

Consider FIG. 1 which illustrates an exemplary environment in which exemplary embodiments of the invention may be practiced to advantage. There is a UE in a CELL-FACH state and under control of a serving cell denoted as cell1. The UE is moving towards two neighbor cells, cell2 and cell3. Cell2 is in the same NodeB-1 group as the serving cell1, while cell3 is in a different NodeB-2 group. Conventionally the geographic area controlled by a NodeB is served by directional antennas. Each NodeB may control several cells, typically arranged in different sectors (e.g., three or six sector sites). While Cell1 and Cell2 may be considered from the network perspective different sectors of the same NodeB cell, since each sector has a different physical configuration the UE sees each sector as a different cell. Similarly, if a NodeB also has relay nodes and/or remote radio heads, the UE will also see those as separate cells rather than distinct sectors under a given NodeB's control. The description below uses the term cell in reference to the network access node which controls a sector (or which controls an entire NodeB geographic area if there are no sector divisions).

The exemplary embodiments of the invention below are described in the initial context of the UE in the Cell-FACH state moving away from its serving cell towards neighbor cell2 and neighbor cell3 so that the UE's received signal strength from cell is diminishing while that from cell2 and cell3 is increasing. While these examples are also in the context of the UTRAN system and specifically HSDPA, such context is for clarity of description and is not itself a limit; these teachings may be employed in that and in other radio access technologies such as evolved UTRAN, WCDMA and others.

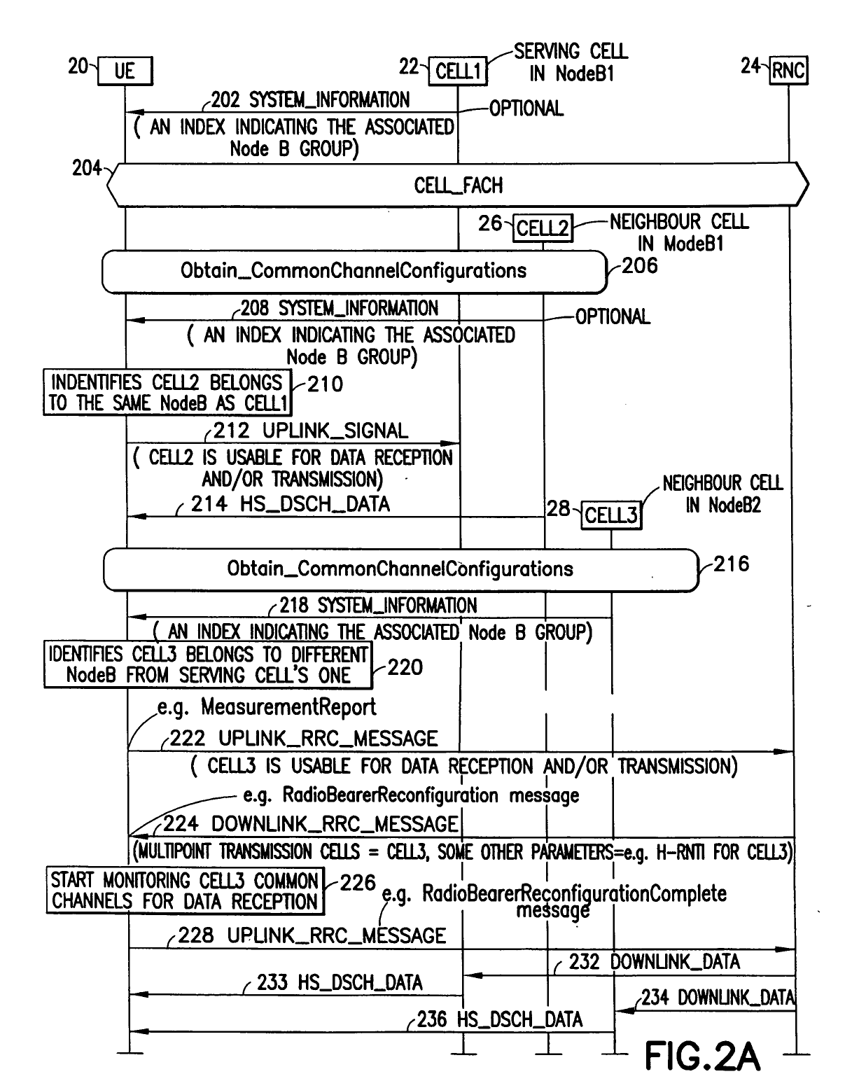

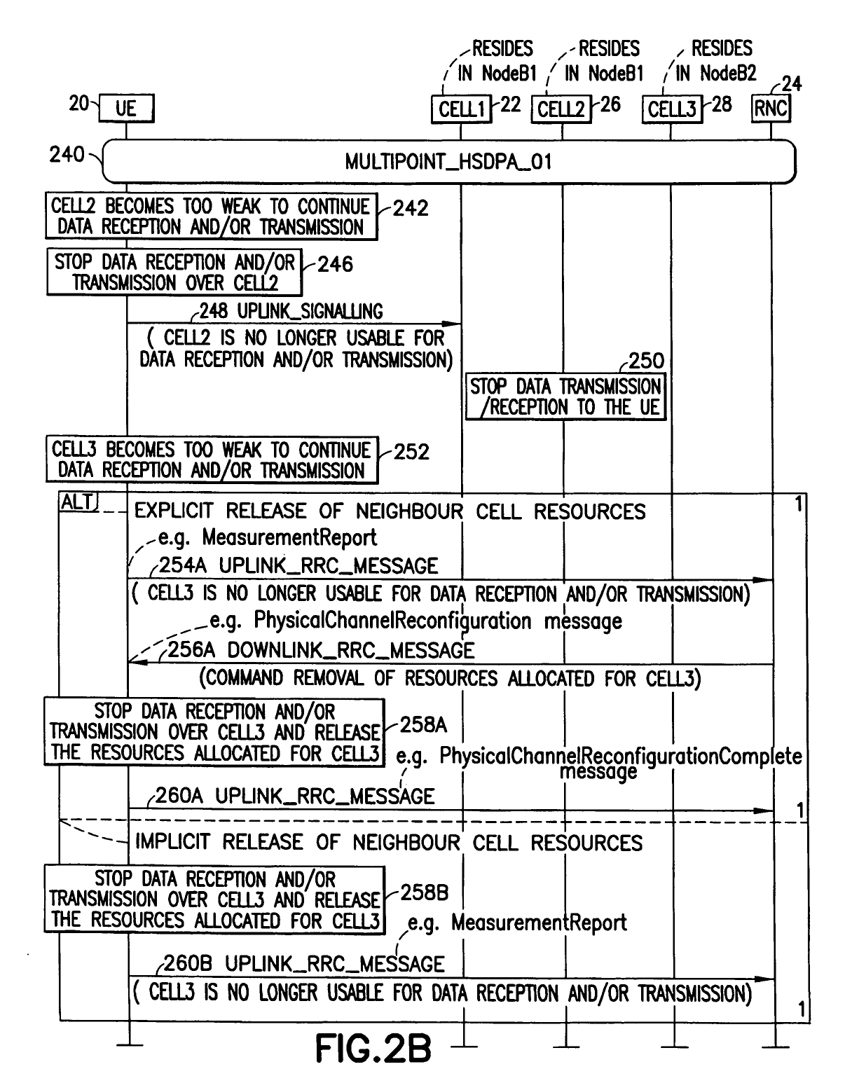

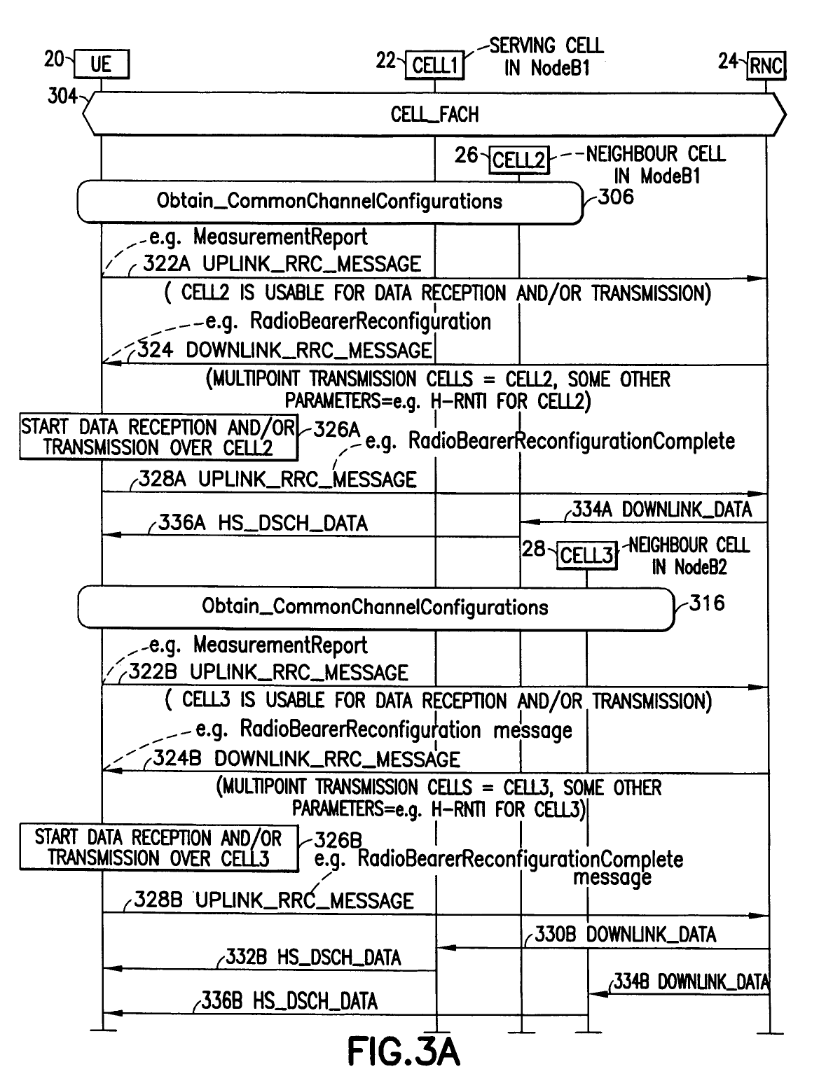

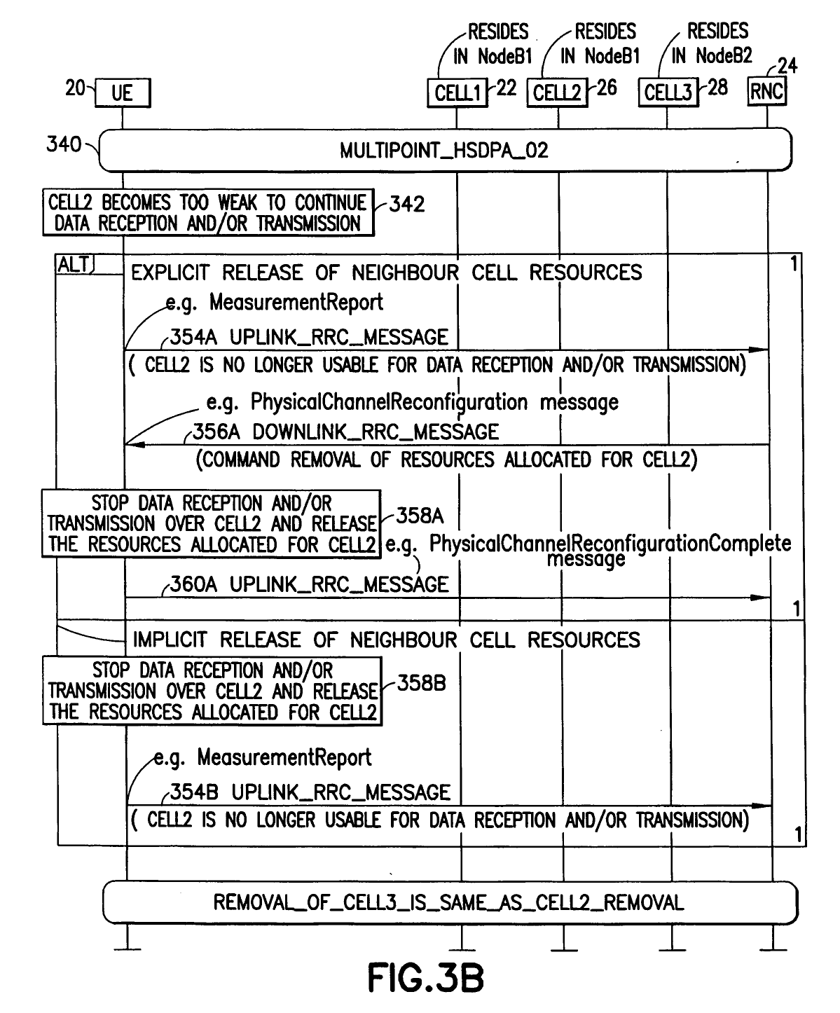

In the following signaling diagrams, FIG. 2A illustrates a first exemplary embodiment for establishing multipoint communications between two network cells (serving cell and neighbor cell2 and/or neighbor cell3) and a UE according, and FIG. 2B illustrates a first exemplary embodiment for discontinuing the multipoint communications first established at FIG. 2A. Respectively, FIGS. 3A and 3B illustrate similarly for a second exemplary embodiment. Within FIGS. 2B and 3B are two options for how the neighbor cell radio resources for the multipoint communications are released; by explicit signaling and implicit within other signaling. These examples are operative for UL transmissions by the UE and multipoint reception at the network nodes/cells, for DL multipoint transmissions by the network nodes/cells for reception at the UE, and for both UL and DL. Each of these are encompassed by the more generic term multipoint communications, in which the UE uses more than one serving HS-DSCH cell in the CELL-FACH state for downlink data reception (multipoint HSDPA operation in CELL-FACH) or uplink data transmission.

Now consider the first embodiment at FIG. 2A for establishing multipoint communications. For the multipoint HSDPA operation in CELL-FACH state 204, the serving cell 22 transmits and the UE 20 receives at 202 an information element IE indicating to what NodeB group the serving cell 22 belongs so that the UE can identify whether or not some other neighbor cell the UE later measures belongs to the same or different NodeB as the current serving cell 22. By example the NodeB group may be indicated by an index number of NodeB groups. In further portions of FIG. 2A, the first neighbor cell 26 is within the same NodeB group as the serving cell 22 and the second neighbor cell 28 is in a different NodeB group. As well as indicating the grouping of the serving cell 22, in an exemplary embodiment the serving cell 22 may also indicate the grouping of neighbor cells in the neighbor cell list which the serving cell 22 signals to the UE 20. Alternative to signaling the NodeB group indication in the IE, the serving cell 22 may broadcast that information in system information.

The UE 20 either sees its received signal strength or quality from the serving cell 20 dropping, or it sees its received signal strength or quality from the neighbor cell 26 increasing or anticipates that it eventually will and so the UE 20 obtains the common channel configuration parameters 206 for its communications with the neighbor cell 26. In one embodiment the UE 20 obtains this from system information 208 broadcast by the neighbor cell 26, or alternatively from a dedicated message sent by the serving cell 22. In a UTRAN specific implementation, the network signals the parameters 206 for HS-DSCH reception while the UE 20 is in the CELL-FACH state in SIB5, and the IE indicating to what NodeB group the cell belongs is also broadcast in SIB5. The UE can know which neighbor cells to measure from a neighbor cell list the UE 20 receives from the network (serving cell 22).

In any case, the UE 20 does receive the SI from the neighbor cell 26 which carries an index or other identifier of which NodeB group that neighbor cell 26 belongs. If the neighbor cell 26 belongs to the same NodeB group as the serving cell 22 as will be first detailed then the UE 20 facilitates multipoint communications with the serving cell 22 and the same-NodeB group neighbor cell 26 according to a first procedure, else if the neighbor cell 28 belongs to a different NodeB group than the serving cell 22 as will be next detailed then the UE 20 facilitates multipoint communications with the serving cell 22 and the different-NodeB group neighbor cell 28 according to a second procedure. This is not mutually exclusive; the UE 20 may choose to facilitate multipoint communications with the serving cell 22, the same-NodeB group neighbor cell 26, and the different-NodeB group neighbor cell 28 by utilizing both first and second procedures.

The UE 20 identifies the neighbor cell 26 as belonging to the same NodeB group as the serving cell 22 at block 210, and so will undertake the first procedure. Based on the UE's measurement of that neighbor cell 26 it sends UL signaling 212 to the serving cell 22 indicating that neighbor cell 26 is useable for data reception and/or transmission to/from the UE 20. This UL signaling may for the first procedure be via a UL physical channel and for the second procedure be via an RRC message.

Still in the first procedure, the network then starts multipoint communications 214 over the serving cell and the same-NodeB group neighbor cell 26 in response to that UL signaling 212. In a specific embodiment for UTRAN, this multipoint communication 214 is HS-DSCH transmission and/or common E-DCH reception over the serving cell 20 and the reported 212 neighbor cell 26; and the UE 20 starts HS-DSCH reception and/or common E-DCH transmission over the serving cell 20 and the reported 212 neighbor cell 26 (or neighbor cells if more than one neighbor cell joins the serving cell 22 in the multipoint communications). Note that the HS-DSCH data 214 of FIG. 2A is sent by or received at both the serving cell 22 and the same-NodeB group neighbor cell 26.

Further portions of FIG. 2A illustrate the second procedure, in which the neighbor cell 28 is a different-NodeB group than the serving cell 22. The UE 20 obtains the common channel configuration parameters 216 for its communications with the neighbor cell 28, either from system information 218 broadcasted by the different-NodeB group neighbor cell 28 or alternatively from a dedicated message sent by the serving cell 22. The UE 20 identifies at block 220 that the neighbor cell 28 belongs to a different NodeB group than the serving cell 22, and so will undertake the second procedure. Based on the UE's measurement of that neighbor cell 28 it sends UL signaling 222 to the RNC 24 indicating that this neighbor cell 28 is useable for data reception and/or transmission to/from the UE 20. As noted above, for the second procedure this UL signaling 222 is an UL RRC message. In one embodiment this RRC message 222 has an explicit indication that the neighbor cell 28 is useable, and in another embodiment the RRC message 222 is a measurement report which implicitly informs the RNC 24 that this neighbor cell 28 is useable for multipoint communications.

Further in the second procedure, the network (e.g., the RNC 24 via the serving cell 22) responds with DL signaling 224 to confirm the UL signaling 222 the uplink signaling, and in certain exemplary embodiments this DL response signaling 224 is a RRC message (e.g., Radio Bearer Reconfiguration message) which provides to the UE 20 parameters for the multipoint communications (if some or all were not received at block 216) and also additional parameters which the UE 20 is to use with that different-NodeB neighbor cell 28. Specific to UTRAN, these parameters may include the H-RNTI for multipoint HS-DSCH reception operation and/or Primary E-RNTI, Secondary E-RNTI, E-RGCH, E-HICH for E-DCH for multipoint E-DCH transmission operation.

Now having the radio bearer and H-RNTI for the different-NodeB group neighbor cell 28, the UE 20 then at block 226 starts to monitor the common channels for data reception, and sends a UL RRC message 228 to the RNC 24 which for a UTRAN implementation may be a Radio Bearer Reconfiguration Complete message (or alternatively Radio Bearer Setup, Radio Bearer Release, Physical Channel Reconfiguration, or Transport Channel Reconfiguration message). The network then starts multipoint communications over the serving cell and the different-NodeB group neighbor cell 28 in response to that UL signaling 228 (e.g. Radio Bearer Setup Complete, Radio Bearer Reconfiguration Complete, Radio Bearer Release Complete, Physical Channel Reconfiguration Complete, or Transport Channel Reconfiguration Complete message). In this case though, if the multipoint communications are DL the RNC 24 sends the DL data to both the serving cell 22 and the different-NodeB group neighbor cell 28 as shown via messages 232 and 234, and the wireless multipoint transmission to the UE 20 from those cells 22, 28 is via the HS-DSCH data messages 233 and 236 respectively. For the first procedure both serving cell 22 and same-NodeB group neighbor cell 26 received the data from the NodeB (but note that either cell 22, 26 may itself be the NodeB). As with the first procedure above, in a specific embodiment for UTRAN this multipoint communication 233 236 may also be common E-DCH reception at the serving cell 20 and the reported 222 neighbor cell 28.

FIG. 2B continues chronologically from FIG. 2A and illustrates a first exemplary embodiment for discontinuing the multipoint communications 240 established there using the same-NodeB group neighbor cell 26 and the different-NodeB group neighbor cell 28. At some point the UE 20 determines at block 242 that the same-NodeB group neighbor cell 26 is either no longer reliable or soon will be, typically but not exclusively due to diminished signal strength the UE 20 receives from it. The UE 20 decides as block 246 to stop the multipoint communications with the same-NodeB group neighbor cell 26 and sends UL signaling 248 to the serving cell 22 that the used neighbor cell 26 is no longer useable for DL data reception and/or UL data transmission. In response the network node coordinating the multipoint communications from the network side (the NodeB in this case) simply discontinues sending the UE's DL data to that neighbor cell 26 and/or discontinues informing that neighbor cell 26 of the UL resources to monitor on which the UE 20 is scheduled to send its UL data. Or the network node coordinating the multipoint communications can explicitly release the neighbor cell 26 from multipoint communications with that specific UE 20. In this case both the serving cell 22 and the neighbor cell 26 are in the same NodeB group and so the node coordinating the multipoint communications will typically be the NodeB. At block 250 the same-NodeB group neighbor cell 26 then stops its transmission to and/or reception from the UE 20.

Further portions of FIG. 2B are directed to the case in which the neighbor cell 28 participating in the multipoint communications 240 is a different-NodeB group than the serving cell 22. Two options are shown, explicit and implicit release of the different-NodeB group neighbor node 28 radio resources. In either case, as with FIG. 2A it may be considered that the UE 20 follows a first procedure for dropping a neighbor cell 26 from multipoint communications (which may or may not terminate the multipoint communications, depending on whether one or more neighbor cells are participating) if the neighbor cell 26 is a same-NodeB group as the serving cell 22, and follows a second procedure for dropping a neighbor cell 28 from multipoint communications if the neighbor cell 28 is a different-NodeB group from the serving cell 22. Both the explicit and the implicit release described below are embodiments of this second procedure. Both releases begin with the UE 20 determining at block 252 that the different-NodeB group neighbor cell 28 is no longer reliable (or soon will be) for data communications and decides at that block to stop the multipoint communications with it.

For the explicit release of different-NodeB group neighbor cell 28 radio resources, the UE 20 sends a UL message 254A to the RNC 24 which by example is a RRC message (e.g., measurement report) which informs explicitly or implicitly that the different-NodeB group neighbor cell 28 is no longer useable for DL data reception and/or UL data transmission. In response the RNC 24 sends in response to message 254A a DL RRC message 256A which commands removal of resources allocated for that different-NodeB group neighbor cell 28. By example, in a UTRAN implementation this may be a Physical Channel Reconfiguration message (or alternatively Radio Bearer Setup, Radio Bearer Reconfiguration, Radio Bearer Release, or Transport Channel Reconfiguration message). At block 258A the UE 20 stops multipoint communications with the different-NodeB group neighbor cell 28 and releases the resources commanded in message 256A, then sends to the RNC 24 an UL RRC message 260A confirming its actions at block 258A. In a UTRAN implementation this UL RRC message 260A is by example a Physical Channel Reconfiguration Complete message (or alternatively Radio Bearer Setup Complete, Radio Bearer Reconfiguration Complete, Radio Bearer Release Complete or Transport Channel Reconfiguration Complete message).

For the implicit release of different-NodeB group neighbor cell 28 radio resources, the UE 20 at block 258B simply stops multipoint communications with the different-NodeB group neighbor cell 28 and releases the radio resources it uses with that different-NodeB group neighbor cell 28 for the multipoint communications 240, and then sends to the RNC 24 an UL RRC message 260B which implicitly confirm its actions at block 258B. In a UTRAN implementation this UL RRC message 260B is by example a measurement report.

In summary, one possible UTRAN specific implementation of this first embodiment is as follows. The network signals the parameters for HS-DSCH reception in CELL-FACH state feature in SIB5 or SIB5bis, and optionally in that SIB5 or SIB5bis also signals the IE which indicates to what NodeB group the cell belongs. The UE 20 finds the neighbor cell SI broadcasts because it measures neighbor cells in a neighbor cell list provided by the network. For the first procedure the UE 20 starts receiving HS-DSCH over the current serving cell 22 and the same-NodeB group neighbor cell 26 and reports to the NodeB about the use of the neighbor cell via uplink physical channel such as HS-DPCCH, E-DPCCH or E-DPDCH. The NodeB then starts sending downlink data over the same-NodeB group neighbor cell 26 after the reception of the report from UE 20. For the second procedure the UE 20 starts receiving HS-DSCH over the current serving cell 22 and the different-NodeB group neighbor cell 28 and reports to the RNC 24 about the use of the neighbor cell 28 via an uplink RRC message (e.g. measurement report).

Alternatively, instead of first and second procedures the UE 20 can use the second procedure for any neighbor cell. Specifically, the UE 20 starts receiving HS-DSCH over the current serving cell 22 and the some neighbor cell 26, 28 regardless of the associated NodeB group and reports to the RNC 24 about the use of the neighbor cell 26, 28 via an uplink RRC message (e.g. measurement report). The network then starts sending downlink data over the neighbor cell 26, 28 after the reception of the uplink RRC message.

For discontinuing a cell from the multipoint communication, the UE reports to the network via an uplink RRC message (e.g. measurement report) that the used neighbor cell 26, 28 is no longer useable (or no longer being used by the UE 20) for the downlink data reception and/or transmission when the used neighbor cell 26, 28 becomes too weak to continue the downlink data reception and/or transmission. Then the network stops sending downlink data over the non-used neighbor cell 26, 28 after the reception of that uplink RRC message.

The second exemplary embodiment noted above is shown in the signaling diagrams of FIGS. 3A-B. For establishing a neighbor cell in multipoint communications at FIG. 3A, the UE 20 is in a CELL-FACH state 304 and the UE 20 gets 306 the parameters for HS-DSCH reception in the CELL-FACH state in SIB5 or SIB5bis of the respective cell's 22, 26 broadcast SI. The UE 20 measures the neighbor cells in a neighbor cell list provided by the network/serving cell 22 and reports the measured neighbor cells to the network/RNC 24 (or at least those which are useable for HSDPA and/or UL data transmission) via an uplink RRC message 322A (e.g. measurement report). In this embodiment the network may decide based on the measurement report 322A that neighbor cell 26 is useable for multipoint communications with the UE 20 (the network will know the UE's capability for multipoint communications from UE capabilities reported during RRC connection establishment or a UE capability information procedure, from contacting the UE's home network or from the class rating the UE reports for itself).

The network (the RNC 24 via the serving cell 22) then sends a downlink RRC message 324A. By example message 324A may for a UTRAN implementation be a Radio Bearer Setup, Radio Bearer Reconfiguration, Radio Bearer Release, Physical Channel Reconfiguration, or Transport Channel Reconfiguration message. This message 324A provides to the UE 20 the configuration parameters for the multipoint communications. For a UTRAN specific implementation, these parameters may be H-RNTI for HS-DSCH reception from and/or Primary E-RNTI, Secondary E-RNTI, E-RGCH, E-HICH for E-DCH for common E-DCH transmission to the neighbor cell 26.

The UE 20 starts at block 326A the multipoint communications (HS-DSCH reception and/or common E-DCH transmission) which now include the newly added neighbor cell 26 and sends a reply message 328A to message 324A. By example this reply RRC message 328A may be a UL Radio Bearer Setup Complete, Radio Bearer Reconfiguration Complete, Radio Bearer Release Complete, Physical Channel Reconfiguration Complete, or Transport Channel Reconfiguration Complete message. The RNC 24 in response to receiving this UL message 328A then begins, for the case of DL multipoint communications, to send DL data 334A addressed to the UE 20 to the newly added neighbor cell 26 as well as to the serving cell 22, and both the newly added neighbor cell 26 and the serving cell 22 transmit this HS-DSCH data 336A to the UE in multipoint fashion. While FIG. 3-A only illustrates DL multipoint communication 336A, for UTRAN this multipoint communication may be implemented in the UL direction as common E-DCH reception at the serving cell 20 and the neighbor cell 26 reported at UL RRC message 322A.

For the case in which the neighbor cell 28 is not in the same NodeB group as the serving cell 22 the procedure in this second exemplary embodiment is much the same, since this embodiment does not entail different procedures depending on what NodeB group the neighbor cell belongs.

The UE 20 in the CELL-FACH state 304 gets from the network at 316 the parameters for HS-DSCH reception in SIB5 or SIB5bis of the respective cell's 22, 28 broadcast SI. The UE 20 measures neighbor cell 28 and sends a measurement report 322B to the network which indicates the neighbor cell 28 is useable for multipoint communications. The network then sends a downlink RRC message 324B (e.g., Radio Bearer Setup, Radio Bearer Reconfiguration, Radio Bearer Release, Physical Channel Reconfiguration, or Transport Channel Reconfiguration message) which provides to the UE 20 the configuration parameters (H-RNTI, E-RNTI, etc.) for the multipoint communications with that neighbor cell 28

At block 326B the UE 20 starts the multipoint communications (HS-DSCH reception and/or common E-DCH transmission) and sends a reply message 328B to the RNC 24 (e.g., Radio Bearer Setup Complete, Radio Bearer Reconfiguration Complete, Radio Bearer Release Complete, Physical Channel Reconfiguration Complete, or Transport Channel Reconfiguration Complete message). The RNC 24 in response to receiving this UL message 328B then begins, for the case of DL multipoint communications, to send DL data addressed to the UE 20 to the newly added neighbor cell 28 at message 334B as well as to the serving cell 22 at message 330B. Both the newly added neighbor cell 28 and the serving cell 22 transmit this HS-DSCH data 332B, 336B to the UE in multipoint fashion.

FIG. 3B continues chronologically from FIG. 3A and shows signaling for when the neighbor cells 26, 28 are dropped from the multipoint communications 340 according to the second exemplary embodiment. The same procedure is used for either neighbor cell 26, 28, and so FIG. 3B describes the process for dropping neighbor cell 26. When the used neighbor cell 26 becomes at block 342 too weak to continue the downlink data reception and/or transmission, for an explicit release of radio resources the UE 20 reports to the network via an uplink RRC message 354A (e.g. measurement report) that the used neighbor cell 26 is no longer used for the downlink data reception and/or transmission. The UE 20 then at block 358A stops data reception and/or transmission over the no longer used neighbor cell 26.

In one specific but non-limiting embodiment of this explicit release, the network replies to the uplink RRC message 354A with a DL RRC message 356A (e.g. Radio Bearer Setup, Radio Bearer Reconfiguration, Radio Bearer Release, Physical Channel Reconfiguration or Transport Channel Reconfiguration message) commanding removal of the radio resources allocated to the neighbor cell 26 for multipoint communications with this UE 20, which the UE 20 responds with a UL RRC message (e.g. Radio Bearer Setup Complete, Radio Bearer Reconfiguration Complete, Radio Bearer Release Complete, Physical Channel Reconfiguration Complete or Transport Channel Reconfiguration Complete message) 360A. Block 358A has the UE stopping data reception and/or transmission over the neighbor cell 26 which is identified in the DL RRC message 356A and releasing the radio resources commanded there prior to signaling the UL confirmation RRC message 360A. In a different specific but non-limiting embodiment of this explicit release the UE 20 may release the resources allocated for the no longer used neighbor cell 26 after transmitting its uplink RRC message (e.g. measurement report) 354A. In either case, for the DL direction the network stops sending downlink data over the non-used neighbor cell 26 after it receives the uplink RRC message 354A.

For an implicit release of radio resources the UE 20 at block 358B stops data reception and/or transmission over the neighbor cell 26 which the UE 20 determined at block 342 was too weak to continue with multipoint communications 340, and sends an UL RRC message 354B (e.g., measurement report) to the RNC 24 informing the network that this neighbor cell 26 is no longer useable for multipoint communications and implicitly informing the network that the radio resources allocated for multipoint communications with this neighbor cell 26 are released/not being used from the UE's perspective.

Whether the resource release is to be done via the implicit or the explicit approach may be advantageously specified in a radio access technology standard (e.g., 3GPP Release 11) so that both network nodes and UEs will know which signaling protocol to use without having to coordinate the decision via control signaling.

One technical effect of the above procedures is that the UE can receive downlink data via using more than one HS-DSCH serving cell so data reception reliability is improved, particularly when the UE is located at the cell edge. Another technical effect is that for common E-DCH operation, the neighbor cell can control its E-DCH transmission power via using the E-RGCH so it can reduce the interference on its neighbor cells due to the common E-DCH operation on the current serving cell.

The description of FIG. 2A provides that the UE 20 decides whether a neighbor cell 26, 28 is suitable for inclusion in its multipoint communications (whether it is suitable for reception by the UE 20 of the HS-DSCH). The UE 20 can also make this decision for the FIG. 3A implementation. At FIG. 2A the UE 20 decodes the SI 208, 218 of the neighbor cell 26, 28.

Below are detailed various criteria by which the UE 20 can use to determine whether it should attempt to decode that neighbor cell's SI in order to obtain the configuration that can be added to its list of available cells for multipoint communications. Such criteria may also be used by the UE 20 to determine when a previously suitable cell 26, 28 should no longer be considered suitable and hence should be removed from ongoing multipoint communications with that UE 20. These criteria may be used individually or in any combination.

A first criterion is for the UE 20 to use an absolute or relative threshold which must be met for the measured neighbor cell to be considered suitable or no longer suitable. If the cell meets the threshold, then if it is not yet included in multipoint communications the UE 20 should attempt to acquire its SI and if it is acquired the cell is added to the list of available cells. If the cell drops below the threshold then the cell is removed from the list of available cells.

A second criterion modifies the first criteria above in that a “time to trigger” is added. To prevent changing signal strength in fading channel conditions from causing a cell to be added to and dropped from the list, the absolute or relative threshold must be met for some non-negligible time interval, for example one second. In addition, hysteresis (lagging effect or path dependence) and cell individual offsets can be added to the above thresholds for determining when the UE autonomously attempts to acquire the SI and when it decides a cell can be dropped from ongoing multipoint communications. The specific values for when to attempt to acquire the SI and when to attempt to drop may differ even though the criteria concepts are the same (e.g., “leaving conditions” versus “entering conditions”).

A third criterion for the UE 20 may be used in addition to the two above; the UE 20 informs the network (212 and 222 of FIG. 2A; 322A and 322B of FIG. 3A) that a neighbor cell is suitable for multipoint communications only once the UE 20 has synchronized to that cell's downlink common HS-DSCH. Similarly, any time the UE detects on that channel that it is out of synchronization with that cell then the UE 20 decides to drop that cell from multipoint communications. For the latter case the drop decision is made regardless of any other criteria.

A fourth criterion is that the UE 20 uses an absolute or relative threshold which applies for the measured serving cell 22. In this case the UE stops HS-DSCH reception from the neighbor cell(s) 26, 28 if the serving cell signal quality is above or equal to the threshold, and starts HS-DSCH reception from the neighbor cell(s) if the serving cell 22 signal quality is below the threshold.

In addition to those listed above, the UE 20 may also consider its power supply status for determining whether starting or stopping HS-DSCH reception from some cell other than the serving cell. In this manner the UE 20 may avoid or reduce battery drain due to the multipoint HSDPA reception. Any or all of the above criteria may be used by the UE 20 to autonomously decide to add or drop a neighbor cell from its list of suitable candidate cells for multipoint communications.

In one embodiment, the serving cell 22 signals to the UE 20 its ability to perform multipoint communications in the CELL-FACH state, and also the relevant criteria parameters for adding and/or removing cells from the UE's list of suitable candidates for multipoint communications. Cell specific information could be either transmitted from the serving cell 22, or obtained from the individual neighbor cells 26, 28 after SI acquisition (but at least SI acquisition criteria needs to be signaled from the serving cell 22). In an alternate embodiment the network signals in the UE's reconfiguration to the CELL-FACH state, transmitted on the serving cell 22, the ability to perform multipoint transmission in CELL-FACH state and also the relevant criteria parameters for adding/removing neighbor cells from the UE's candidate list. In still another alternative embodiment the parameters are fixed (e.g., published in a wireless standard) and so need not be signaled.

In practice, it is expected the UE 20 will start monitoring the relevant neighbor cells (in any state) and build/maintain a list of suitable cells based on the criteria for addition/removal, and obtain the neighbor cell's system information if necessary. Then once the UE 20 enters the CELL-FACH state, or when the list of suitable cells changes based on the criteria, the UE 20 indicates to the network the list of available cells. The UE 20 starts HS-DSCH reception on the neighbor cell(s) using multipoint communications (per FIG. 2A or 3A) if the given criteria are met.

These add/drop criteria for the UE's candidate list exhibits the following technical effects. Having specified rules for when the UE 20 can consider a neighbor cell to be suitable results in more predictable behavior from the network's perspective. For implementations in which the parameters/criteria are signaled by the network, this allows the network to control the criteria and tailor it to different deployment scenarios. It also avoids failed SI acquisition attempts, which result in reduced UE power consumption. It also avoids the UE 20 adding a neighbor cell for which it has obtained SI when that same recently added neighbor cell does not provide sufficiently good reception of the HS-DSCH. And additionally it avoids battery drain due to multipoint HSDPA operation when the serving cell is strong enough to receive downlink data reliably.

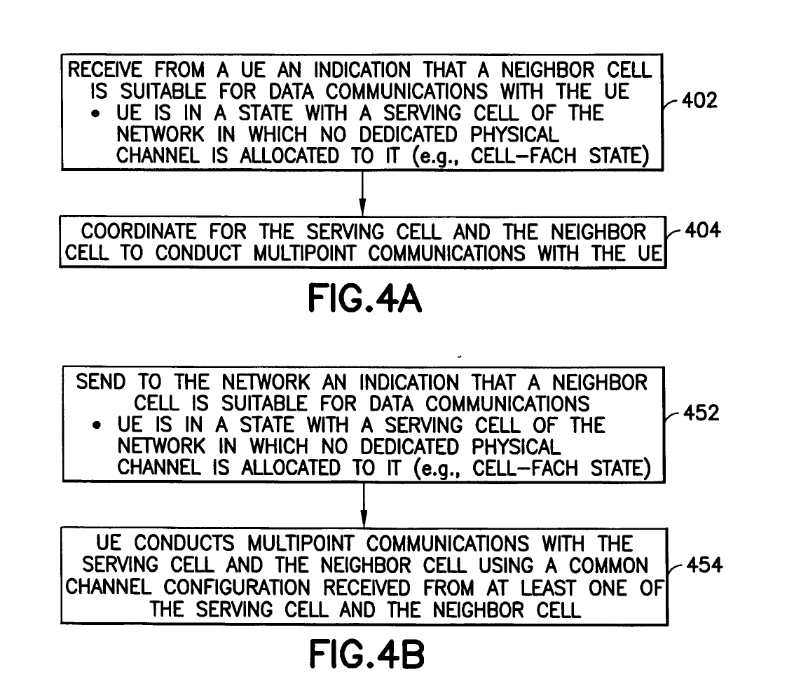

Now are detailed with reference to FIGS. 4A-B further particular exemplary embodiments from the perspective of the network (FIG. 4A) and the UE (FIG. 4B). At block 402 of FIG. 4A the network receives from a UE an indication that a neighbor cell is suitable for data communications with the UE. In this case the UE is in a state with a serving cell of the network in which no dedicated physical channel is allocated to the UE (e.g., CELL-FACH state). In response to block 402, at block 404 the network coordinates for the serving cell and the neighbor cell to conduct multipoint communications with the UE.

From the UE's perspective at FIG. 4B, block 452 finds the UE sending to the network an indication that a neighbor cell is suitable for data communications with the UE. In this case also the UE is in a state with a serving cell in which no dedicated physical channel is allocated to the UE (e.g., CELL-FACH state). In response to block 452, then at block 454 the UE conducts multipoint communications with the serving cell and the neighbor cell using a common channel configuration received from at least one of the serving cell and the neighbor cell.

In the specific embodiments detailed above, the indication of blocks 402 and 452 may be a measurement report with a list of suitable candidate neighbor cells which the UE sends to the network. Coordinating at block 404 may the network sending to the UE a Radio Bearer Reconfiguration message (or alternatively Radio Bearer Setup, Radio Bearer Release, Physical Channel Reconfiguration or Transport Channel Reconfiguration message) which includes parameters for the multipoint communications between the user equipment and the neighbor cell. For the NodeB group specific procedures, the serving cell and the neighbor cell broadcast in their respective system information an indication of which NodeB group they belong, and the coordinating of block 404 is then by a common NodeB for the case the serving cell and the neighbor cell belong to the same NodeB group, and the coordinating of block 404 is by a radio network controller for the case the serving cell and the neighbor cell belong to different NodeB groups.

In the add/drop criteria described above in detail, the network may further send to the UE parameters for deciding when a given neighbor cell is suitable for data communications with the UE and for deciding when a given neighbor cell is no longer suitable for ongoing data communications with the UE; the add parameters may or may not be the same as the drop parameters.

Once the neighbor cell is no longer suitable, the UE in an embodiment sends a further or second indication (separate from the indication of blocks 402 and 452) that the neighbor cell is no longer suitable for data communications with the UE; and in response the multipoint communications between the neighbor cell and the user equipment are discontinued as variously shown at FIGS. 2B and 3B.

FIGS. 4A-B are logic flow diagrams which may be considered to illustrate the operation of a method, and a result of execution of a computer program stored in a computer readable memory, and a specific manner in which components of an electronic device are configured to cause that electronic device to operate. The various blocks shown in FIGS. 4A-B may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

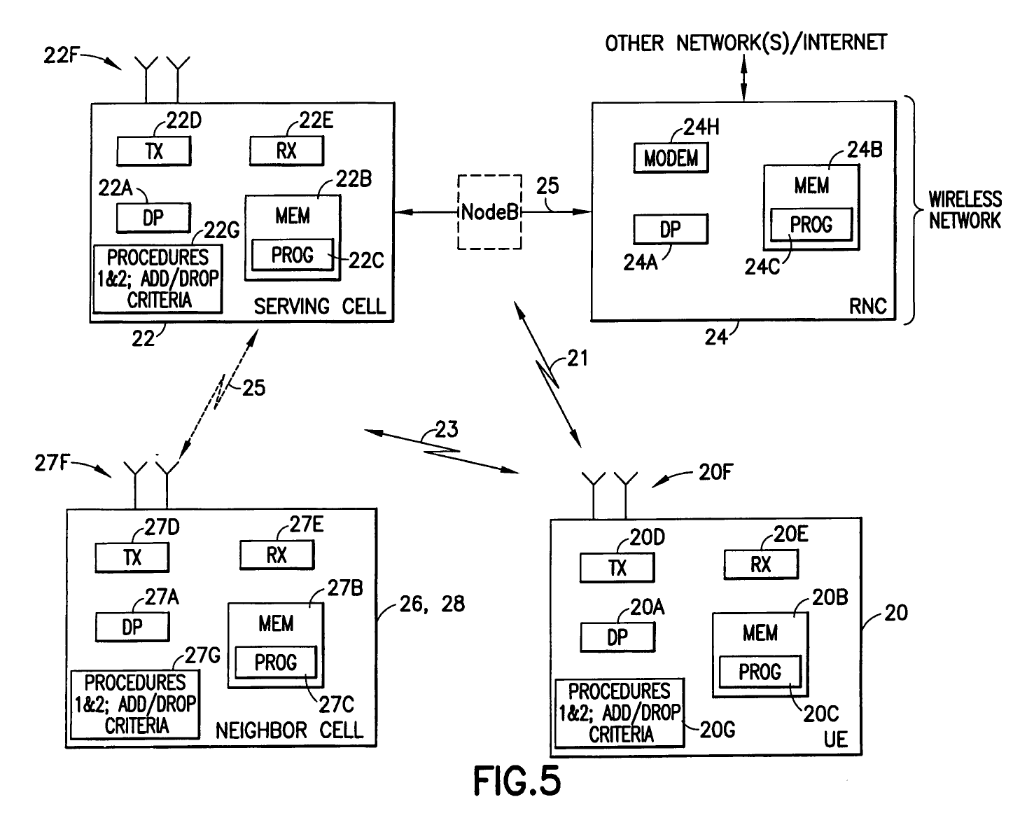

Reference is now made to FIG. 5 for illustrating a simplified block diagram of various electronic devices and apparatus that are suitable for use in practicing the exemplary embodiments of this invention. In FIG. 5 a wireless network (serving cell 22, neighbor cell 26 or 28, NodeB if the serving and neighbor cells are other than the NodeB, and RNC 24) is adapted for communication over wireless links 21, 23 with an apparatus, such as a mobile terminal or UE 20. The network may include a network control element RNC 24, which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the node B 22 via one or more antennas 20F. Also stored in the MEM 20B at reference number 20G is the different procedures in case the serving 22 and neighbor 26, 28 cells are the same or different NodeB groups and the add/drop criteria which the UE 20 receives from the serving cell 22, as detailed above.

The serving cell 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. The neighbor cell is functionally similar with blocks 27A, 27B, 27C, 27D and 27E, and both the serving cell 22 and the neighbor cell 26, 28 also store at 22G and 27G the different procedures and the add/drop criteria. There is also a data and/or control path 25 coupling the neighbor cell 26, 28 and the serving cell 22 to the RNC 24 via the NodeB (if neither cell is the NodeB itself).

Similarly, the RNC 24 includes processing means such as at least one data processor (DP) 24A, storing means such as at least one computer-readable memory (MEM) 24B storing at least one computer program (PROG) 24C, and communicating means such as a modem 24H for bidirectional communications with the cells 22, 26, 28 via the data/control path 25. While not particularly illustrated for the UE 20 or cells 22, 26, 28, those devices are also assumed to include as part of their wireless communicating means a modem which may be inbuilt on an RF front end chip within those devices 20, 22, 26, 28 and which also carries the TX 20D/22D/27D and the RX 20E/22E/27E.

At least one of the PROGs 20C in the UE 20 is assumed to include program instructions that, when executed by the associated DP 20A, enable the device to operate in accordance with the exemplary embodiments of this invention, as will be discussed below in greater detail. The cells 22, 26, 28 and RNC 24 may also have software to implement certain aspects of these teachings for processing and signaling as detailed above. In these regards the exemplary embodiments of this invention may be implemented at least in part by computer software stored on the MEM 20B, 22B, 27B which is executable by the DP 20A of the UE 20 and/or by the DP 22A/27A of the cells 22, 26, 28, or by hardware, or by a combination of tangibly stored software and hardware (and tangibly stored firmware). Electronic devices implementing these aspects of the invention need not be the entire UE 20 or cell 22, 26, 28 or RNC 24, but exemplary embodiments may be implemented by one or more components of same such as the above described tangibly stored software, hardware, firmware and DP, or a system on a chip SOC or an application specific integrated circuit ASIC or a digital signal processor DSP.

In general, the various embodiments of the UE 20 can include, but are not limited to: cellular telephones; data cards, USB dongles, personal portable digital devices having wireless communication capabilities including but not limited to laptop/palmtop/tablet computers, digital cameras and music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A/22A/27A/24A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the UTRAN system, it should be appreciated that the exemplary embodiments of this invention are not limited for use with only this one particular type of wireless communication system, and that they may be used to advantage in other wireless communication systems such as for example GERAN, E-UTRAN and others.

Further, the various names used in the above description (e.g., CELL-FACH state, names of the various channels) are not intended to be limiting in any respect, as different radio technologies may use different terms for similar concepts. Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method, comprising:
receiving from a user equipment an indication that a neighbor cell is suitable for data communications with the user equipment, in which the user equipment is in a state with a serving cell in which no dedicated physical channel is allocated to the user equipment; and in response,
coordinating for the serving cell and the neighbor cell to conduct multipoint communications with the user equipment.

2. The method according to claim 1, in which:
the state is a CELL-FACH state;
the indication is received in a first Radio Resource Control Measurement Report; and
coordinating comprises sending to the user equipment a Radio Resource Control message which includes parameters for the multipoint communications between the user equipment and the neighbor cell;
in which the first Radio Resource Control message comprises one of a Radio Bearer Setup, Radio Bearer Reconfiguration, Radio Bearer Release, Physical Channel Reconfiguration and a Transport Channel Reconfiguration message.

3. The method according to claim 1, further comprising each of the serving cell and the neighbor cell broadcasting in system information an indication of which NodeB group they belong;
in which the coordinating is by a common NodeB for the case the serving cell and the neighbor cell belong to the same NodeB group, and the coordinating is by a radio network controller for the case the serving cell and the neighbor cell belong to different NodeB groups.

4. The method according to claim 1, further comprising sending to the user equipment parameters for deciding when a given neighbor cell is suitable for data communications with the user equipment and for deciding when a given neighbor cell is no longer suitable for ongoing data communications with the user equipment.

5. The method according to claim 1, further comprising:
receiving from the user equipment a further indication that the neighbor cell is no longer suitable for data communications with the user equipment; and in response
discontinuing the multipoint communications between the neighbor cell and the user equipment.

6. The method according to claim 5, in which:
the further indication is received in a second Radio Resource Control Measurement report message, and
discontinuing the multipoint communications comprises:
sending to the user equipment a second Radio Resource Control message which commands the release radio resources allocated for the multipoint communications between the neighbor cell and the user equipment, in which the second Radio Resource Control message comprises one of a Radio Bearer Setup, Radio Bearer Reconfiguration, Radio Bearer Release, Physical Channel Reconfiguration or Transport Channel Reconfiguration message; and in response receiving from the user equipment a third Radio Resource Control message in which the third Radio Resource Control message comprises one of a Radio Bearer Setup Complete, Radio Bearer Reconfiguration Complete, Radio Bearer Release Complete, Physical Channel Reconfiguration Complete or Transport Channel Reconfiguration Complete message.

7. The method according to claim 1 executed by a wireless network, in which the state is a CELL-FACH state; the method further comprising:
sending to the user equipment parameters by which to determine whether a neighbor cell from data communications with the user equipment;
in at least one system information block, broadcasting parameters for HS-DSCH reception in the CELL-FACH state and an indication of which NodeB group the serving cell and the neighbor cell belong;
sending to the user equipment a neighbor cell list which comprises the said neighbor cell;
the received indication comprises a first Radio Resource Control Measurement report;
for the case the serving cell and the neighbor cell belong to the same NodeB group the coordinating is by a common NodeB and for the case the serving cell and the neighbor cell belong to different NodeB groups the coordinating is by a radio network controller;
receiving from the user equipment a second Radio Resource Control Measurement report indicating that the neighbor cell is no longer suitable for data communications; and in response,
discontinuing the multipoint communications between the neighbor cell and the user equipment.

8. An apparatus comprising:
at least one processor; and
at least one memory storing a computer program;
in which the at least one memory with the computer program is configured with the at least one processor to cause the apparatus to at least:
receive from a user equipment an indication that a neighbor cell is suitable for data communications with the user equipment, in which the user equipment is in a state with a serving cell in which no dedicated physical channel is allocated to the user equipment; and in response,
coordinate for the serving cell and the neighbor cell to conduct multipoint communications with the user equipment.

9. The apparatus according to claim 8, in which:
the state is a CELL-FACH state;
the indication is received in a first Radio Resource Control Measurement Report; and
coordinating comprises sending to the user equipment a Radio Resource Control message which includes parameters for the multipoint communications between the user equipment and the neighbor cell;
in which the first Radio Resource Control message comprises one of a Radio Bearer Setup, Radio Bearer Reconfiguration, Radio Bearer Release, Physical Channel Reconfiguration and a Transport Channel Reconfiguration message.

10. The apparatus according to claim 8, in which each of the serving cell and the neighbor cell broadcast in system information an indication of which NodeB group they belong;
and in which the coordinating is by a common NodeB for the case the serving cell and the neighbor cell belong to the same NodeB group, and the coordinating is by a radio network controller for the case the serving cell and the neighbor cell belong to different NodeB groups.

11. The apparatus according to claim 8, in which the at least one memory with the computer program is configured with the at least one processor to cause the apparatus to further send to the user equipment parameters for deciding when a given neighbor cell is suitable for data communications with the user equipment and for deciding when a given neighbor cell is no longer suitable for ongoing data communications with the user equipment.

12. The apparatus according to claim 8, in which the at least one memory with the computer program is configured with the at least one processor to cause the apparatus to further:
receive from the user equipment a further indication that the neighbor cell is no longer suitable for data communications with the user equipment; and in response
discontinue the multipoint communications between the neighbor cell and the user equipment.

13. The apparatus according to claim 12, in which:
the further indication is received in a second Radio Resource Control Measurement report message, and
the apparatus is configured to discontinue the multipoint communications by:
sending to the user equipment a second Radio Resource Control message which commands the release radio resources allocated for the multipoint communications between the neighbor cell and the user equipment, in which the second Radio Resource Control message comprises one of a Radio Bearer Setup, Radio Bearer Reconfiguration, Radio Bearer Release, Physical Channel Reconfiguration or Transport Channel Reconfiguration message; and in response receiving from the user equipment a third Radio Resource Control message in which the third Radio Resource Control message comprises one of a Radio Bearer Setup Complete, Radio Bearer Reconfiguration Complete, Radio Bearer Release Complete, Physical Channel Reconfiguration Complete or Transport Channel Reconfiguration Complete message.

14. The apparatus according to claim 8, in which the apparatus comprises a wireless network node, and the state is a CELL-FACH state; and the at least one memory with the computer program is configured with the at least one processor to cause the apparatus to further:
send to the user equipment parameters by which to determine whether a neighbor cell from data communications with the user equipment;
broadcast in at least one system information block parameters for HS-DSCH reception in the CELL-FACH state and an indication of which NodeB group the serving cell and the neighbor cell belong;
send to the user equipment a neighbor cell list which comprises the said neighbor cell;
the received indication comprises a first Radio Resource Control Measurement report;
for the case the serving cell and the neighbor cell belong to the same NodeB group the coordinating is by a common NodeB and for the case the serving cell and the neighbor cell belong to different NodeB groups the coordinating is by a radio network controller;
receive from the user equipment a second Radio Resource Control Measurement report indicating that the neighbor cell is no longer suitable for data communications; and in response.
discontinue the multipoint communications between the neighbor cell and the user equipment.

15. A computer readable memory storing a computer program which when executed by at least one processor results in actions comprising:
receiving from a user equipment an indication that a neighbor cell is suitable for data communications with the user equipment, in which the user equipment is in a state with a serving cell in which no dedicated physical channel is allocated to the user equipment; and in response,
coordinating for the serving cell and the neighbor cell to conduct multipoint communications with the user equipment.

16. The computer readable memory according to claim 15, in which:
the state is a CELL-FACH state;
the indication is received in a first Radio Resource Control Measurement Report; and
coordinating comprises sending to the user equipment a Radio Resource Control message which includes parameters for the multipoint communications between the user equipment and the neighbor cell;
in which the first Radio Resource Control message comprises one of a Radio Bearer Setup, Radio Bearer Reconfiguration, Radio Bearer Release, Physical Channel Reconfiguration and a Transport Channel Reconfiguration message.

17. The computer readable memory according to claim 15, the actions further comprising each of the serving cell and the neighbor cell broadcasting in system information an indication of which NodeB group they belong;
in which the coordinating is by a common NodeB for the case the serving cell and the neighbor cell belong to the same NodeB group, and the coordinating is by a radio network controller for the case the serving cell and the neighbor cell belong to different NodeB groups.

18. The computer readable memory according to claim 15, the actions further comprising sending to the user equipment parameters for deciding when a given neighbor cell is suitable for data communications with the user equipment and for deciding when a given neighbor cell is no longer suitable for ongoing data communications with the user equipment.

19. The computer readable memory according to claim 15, the actions further comprising:
receiving from the user equipment a further indication that the neighbor cell is no longer suitable for data communications with the user equipment; and in response
discontinuing the multipoint communications between the neighbor cell and the user equipment.

20. The computer readable memory according to claim 19, in which:
the further indication is received in a second Radio Resource Control Measurement report message, and
discontinuing the multipoint communications comprises:
sending to the user equipment a second Radio Resource Control message which commands the release radio resources allocated for the multipoint communications between the neighbor cell and the user equipment, in which the second Radio Resource Control message comprises one of a Radio Bearer Setup, Radio Bearer Reconfiguration, Radio Bearer Release, Physical Channel Reconfiguration or Transport Channel Reconfiguration message; and in response receiving from the user equipment a third Radio Resource Control message in which the third Radio Resource Control message comprises one of a Radio Bearer Setup Complete, Radio Bearer Reconfiguration Complete, Radio Bearer Release Complete, Physical Channel Reconfiguration Complete or Transport Channel Reconfiguration Complete message.

21.-40. (canceled)
